(19) United States
(12) Patent Application Publication
(10) Pub. No.: US 2017/0105223 A1
(43) Pub. Date: Apr. 13, 2017

(54) INTERFERENCE COORDINATION METHOD AND APPARATUS AND COMMUNICATION SYSTEM

(71) Applicant: FUJITSU LIMITED, Kawasaki-shi (JP)

(72) Inventors: Yi ZHANG, Beijing (CN); Hua ZHOU, Beijing (CN)

(73) Assignee: FUJITSU LIMITED, Kawasaki-shi (JP)

(21) Appl. No.: 15/387,159

(22) Filed: Dec. 21, 2016

Related U.S. Application Data
(63) Continuation of application No. PCT/CN2014/080966, filed on Jun. 27, 2014.

(51) Int. Cl. H04W 72/08; H04W 72/12; H04W 72/04; H04W 16/28

(52) U.S. Cl. CPC H04W 72/082; H04W 16/28; H04W 72/12; H04W 72/0473

(57) ABSTRACT

A method and apparatus and a communication system includes: an eNB determines an interference beam interfering with a beam of other cell according to a measurement result reported by user equipment and/or an interference coordination request transmitted by other eNB, and performs interference coordination on the interference beam, including: coordinating with the other eNB for a time-frequency resource used by the interference beam, so that time-frequency resources used by the interference beam and the beam of the other eNB interfering with the interference beam for scheduling user equipment are different, and/or reducing transmission power of the interfering beam, and/or increasing a width of the interfering beam, and/or scheduling multiple user equipment at the same time on the interfering beam and other beams. The method of the embodiments of the present disclosure, an effective interference coordination mechanism is adopted to obtain a good tradeoff between a transmission signal and the interference.

### CROSS REFERENCE TO RELATED APPLICATIONS

This application is a continuation application of International Application PCT/CN2014/080966 filed on Jun. 27, 2014, the entire contents of which are incorporated herein by reference.

### FIELD

The present disclosure relates to the field of communications, and in particular to an interference coordination method and apparatus and a communication system.

### BACKGROUND

As the development of antenna technologies, large amount of antennas may be arranged at a transmitter end. Joint transmission of multiple antennas may improve efficiency and reliability of transmission of the system. Three dimensions (3D) beam forming in a multiple input multiple output (MIMO) system is one of such technologies, which improves gains of the antennas, reduces beam widths, efficiently suppresses white noises and inter-cell random interference, and improves efficiency and reliability of transmission of the system, and is a hot candidate technology in future mobile communication systems.

In the 3D beam-forming technology, a relatively ideal case is that the beams may change along with user equipment (UE), thereby providing relatively good services to the user equipment. In such a case, widths, power and numbers of the beams of each user equipment may be different. And furthermore, in the 3D beam-forming technology, if relatively ideal beam-forming is used for central user equipment, it is possible that the beam has a very intense radiation range, hence, the beam will cause relatively intense interference to neighboring cells. Such a phenomenon is referred to as “a flashlight effect”, as shown in FIG. 1.

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY

Embodiments of the present disclosure provide an interference coordination method and apparatus and a communication system, so as to obtain a good tradeoff between a transmission signal and the interference.

According to a first aspect of the embodiments of the present disclosure, there is provided an interference coordination apparatus, applicable to an eNB, wherein the apparatus includes:
a determining unit configured to determine an interference beam interfering with a beam of other cell according to a measurement result reported by user equipment and/or an interference coordination request transmitted by other eNB; and
a processing unit configured to perform interference coordination on the interference beam.

According to a second aspect of the embodiments of the present disclosure, there is provided an interference coordination apparatus, applicable to user equipment, wherein the apparatus includes:
a first measuring unit configured to perform measurement on a beam of an eNB according to a configured reference signal, and report a measurement result to the eNB; and
a second measuring unit configured to perform CSI measurement according to CSI process bound with a beam and configured by the eNB, and report a measurement result to the eNB, so that the eNB determines an interference beam interfering with a beam of other cell according to the measurement result reported by the user equipment and/or an interference coordination request transmitted by other eNB, performs interference coordination on the interference beam, and selects an appropriate beam for transmission to the user equipment.

According to a third aspect of the embodiments of the present disclosure, there is provided a communication system, including an eNB and user equipment, wherein,
the user equipment is configured to perform measurement on a beam of an eNB according to a configured reference signal, report a measurement result to the eNB, perform CSI measurement according to CSI process bound with a beam and configured by the eNB, and report a measurement result to the eNB;
and the eNB is configured to determine an interference beam interfering with a beam of other cell according to a measurement result reported by the user equipment and/or an interference coordination request transmitted by other eNB, and perform interference coordination on the interference beam.

An advantage of the embodiments of the present disclosure exists in that with the embodiments of the present disclosure, an effective interference coordination mechanism is adopted to obtain a good tradeoff between a transmission signal and the interference.

With reference to the following description and drawings, the particular embodiments of the present disclosure are disclosed in detail, and the principles of the present disclosure and the manners of use are indicated. It should be understood that the scope of the embodiments of the present disclosure is not limited thereto. The embodiments of the present disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the exemplary embodiments of the present disclosure, and are used for setting forth the principles of the present disclosure together with the description. It is clear and understood that the accompanying drawings in the following description are some embodiments of the present disclosure only, and a person of ordinary skill in the art may obtain other accompanying drawings according to these accompanying drawings without making an inventive effort. In the drawings:

FIG. 1 is a schematic diagram of a flashlight effect in the 3D beam-forming technology;

FIG. 2 is a flowchart of an implementation of an interference coordination method of an embodiment of the present disclosure;

FIG. 3 is a flowchart of information interchange between an eNB and user equipment in performing measurement;

FIG. 4 is a schematic diagram of an implementation scenario of an interference coordination manner of an embodiment of the present disclosure;

FIG. 5 is a schematic diagram of an implementation scenario of another interference coordination manner of the embodiment of the present disclosure;

FIG. 6 is a schematic diagram of an implementation scenario of still another interference coordination manner of the embodiment of the present disclosure;

FIG. 7 is a schematic diagram of an implementation scenario of yet another interference coordination manner of the embodiment of the present disclosure;

FIG. 8 is a flowchart of another implementation of the interference coordination method of the embodiment of the present disclosure;

FIG. 9 is a schematic diagram of a structure of an implementation of an interference coordination apparatus of an embodiment of the present disclosure;

FIG. 10 is a schematic diagram of a structure of an eNB including the interference coordination apparatus of FIG. 9;

FIG. 11 is a schematic diagram of a structure of another implementation of the interference coordination apparatus of the embodiment of the present disclosure;

FIG. 12 is a schematic diagram of a structure of user equipment including the interference coordination apparatus of FIG. 11; and

FIG. 13 is a schematic diagram of a network architecture of a communication system of an embodiment of the present disclosure.

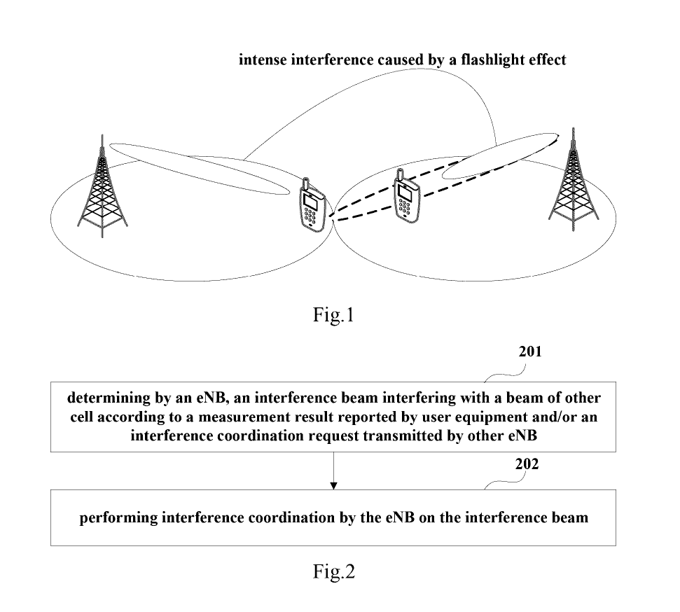

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

### Embodiment 1

An embodiment of the present disclosure provides an interference coordination method. FIG. 2 is a flowchart of the method. Referring to FIG. 2, the method includes:
step 201: determining by an eNB, an interference beam interfering with a beam of other cell according to a measurement result reported by user equipment and/or an interference coordination request transmitted by other eNB; and
step 202: performing interference coordination by the eNB on the interference beam.

In this embodiment, each user equipment may measure beams of an eNB according to a configured reference signal, and report the measurement result, such as information on reference signal receiving power (RSRP), and reference signal receiving quality (RSRQ), etc., to the eNB. And after receiving the measurement result reported by the user equipment, the eNB may configure the user equipment according to the measurement result to perform channel station information (C SI) measurement. In this embodiment, CSI processes configured by the eNB for the user equipment may be bound with the beams. For example, different CSI processes correspond to different beams, and at this moment, the channel measurement at the user equipment side is beam-based. Hence, the eNB may select an appropriate beam for transmission to the user equipment according to the measurement result of the user equipment, or optionally, in conjunction with interference coordination requests from other eNBs.

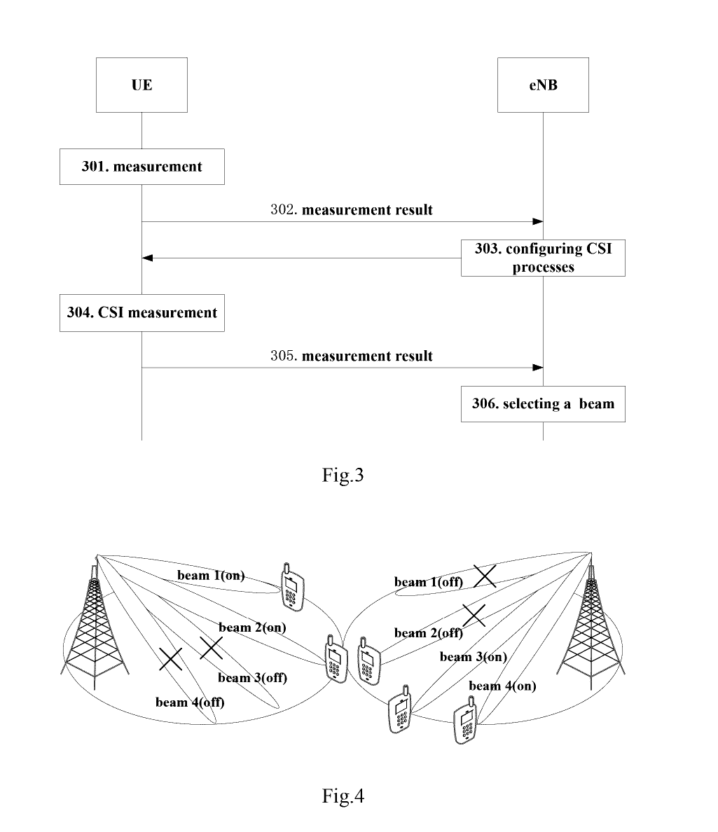

FIG. 3 is a flowchart of information interchange between the eNB and the user equipment in performing measurement based on the beams. Referring to FIG. 3, the flow includes:
step 301: measuring the beams of the eNB by the user equipment according to the configured reference signal;
step 302: reporting the measurement result, such as RSRP, and RSRQ, etc., by the user equipment;
step 303: configuring the user equipment with CSI processes bound with the beams by the eNB according to the measurement result reported by the user equipment;
step 304: performing CSI measurement by the user equipment according to the CSI processes configured by the eNB;
step 305: reporting the measurement result, such as rank indication (RI), a precoding matrix indicator (PMI), and a channel quality indicator (CQI), etc., by the user equipment; and
step 306: selecting an appropriate beam by the eNB for transmission to the user equipment according to the measurement result reported by the user equipment and/or interference coordination requests from other eNBs.

In this embodiment, the above other eNBs and the above eNB may be the same eNB, and may also be different eNBs. If they are the same eNB, the above interference coordination requests may be obtained directly, and if they are different eNBs, the other eNBs and the eNB further exchange the above interference coordination requests, which shall be described below.

In this embodiment, the eNB may determine the beams possibly causing interference on other cells or determine which beams are possibly interfered by other cells according to the measurement result reported by the user equipment and/or the interference coordination requests transmitted by the other eNBs. Such beams are referred to as interference beams in this embodiment, and the selection of an appropriate beam by the eNB includes performing interference coordination on the interference beams.

In an implementation, the eNB may perform interference coordination on the interference beams by scheduling the user equipment at time-frequency resources different from the time-frequency resources used by beams in the other cells interfering with the interference beams. That is, the eNB may coordinate with the other eNBs for the time-frequency resources used by the interference beams, such that the interference beams and the beams of the other eNBs interfering with the interference beams use different time-frequency resources to schedule the user equipment.

FIG. 4 is a schematic diagram of an implementation scenario of this implementation. As shown in FIG. 4, it is possible that beam 2 of a right cell interferes with beam 1 of a left cell, and an eNB of the right cell needs to perform interference coordination on beam 2.

In this implementation, serving users of these two beams may be coordinated via time-frequency resources, so as to achieve that there exists only one beam transmitting data at positions of the same time-frequency resources. That is, time-division multiplexing or frequency-division multiplexing is performed on the beams interfering with each other in the two cells to schedule the user equipment. Such a manner is also referred to as “coordinated beams on/off”, that is, relative to one of the beams interfering with each other, the other beam is in an off state. Actually, the other beam is not really closed, and it just schedules the user equipment by using time-frequency resources different from those used by the one beam.

In this implementation, in order to support such dynamic beam on/off, the eNB may indicate the beams used in the transmission, that is, the selected beams, to the user equipment via dynamic signaling and/or high-layer signaling.

In this implementation, for indication manner using dynamic signaling, explicit beam indication field (BIF) bits may be used, a manner of joint indication in conjunction with demodulation reference signal (DM-RS) port may also be used, that is, a joint bit field is used to indicate a beam used in transmission and a DM-RS port number used in the beam, and a manner of combining dynamic signaling and semi-static signaling may also be used, that is, beams at the eNB end are grouped according to their relevance first, with beams of relatively strong relevance being placed in one group, and then serial numbers of beams used in transmission in the beam groups are indicated via the dynamic signaling, the beam groups are indicated via the semi-static signaling, thereby reducing signaling overhead.

In this implementation, for indication manner using high-layer signaling, which is applicable to a case that the above coordination beam on/off supports only the semi-static. At this moment, the eNB may inform the beams used in transmission to the user equipment via high-layer signaling. The high-layer signaling may use a method similar to indicating a cell identification (ID), in which the number of bits is dependent on the maximum number of beams, and cell ID of different cells may be reused.

In another implementation, the eNB may perform interference coordination on an interference beam by lowering transmission power of the interference beam.

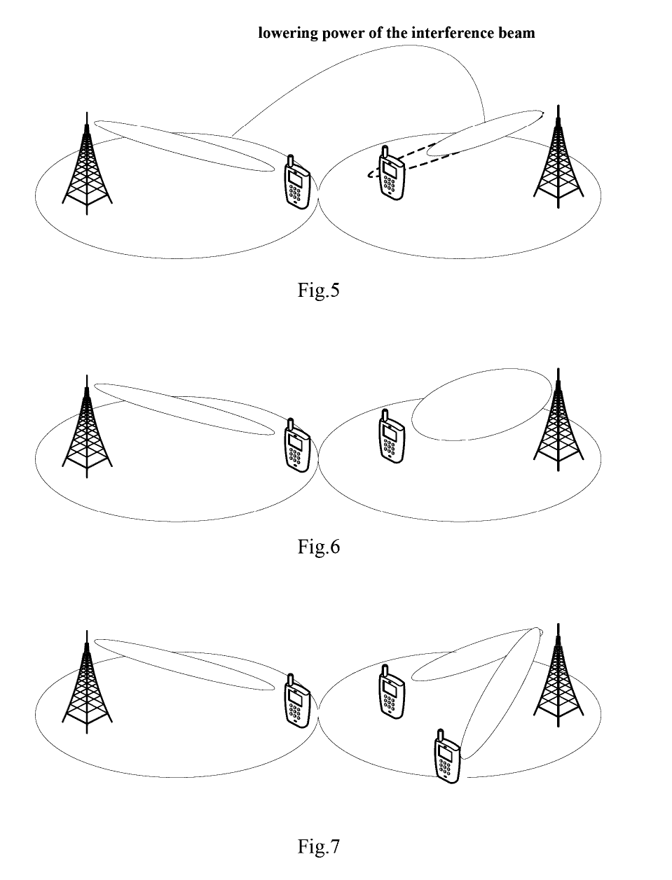

FIG. 5 is a schematic diagram of an implementation scenario of this implementation. As shown in FIG. 5, interference on the beams in the left cell is reduced by lowering power of the beams in the right cell.

In this implementation, in order to ensure accuracy of channel feedback at the UE side, the eNB may transmit information on energy allocation of the beams used in transmission to the user equipment. In this implementation, the information on energy allocation may be information on power of the beams in a time domain or a frequency domain, that is, for each beam, the eNB gives indication on emitting energies in a time or a frequency. For example, in some subframes or bands, power of the eNB is emitted at full power, in some subframes or bands, power of the eNB is emitted at half power, and in some subframes or bands, the eNB transmits some beams.

In this implementation, for the indication on emitting energy, i.e. power indication, a Pc parameter in the channel state information reference signal (CSI-RS) may be reused, that is, the information on power may be indicated by the Pc parameter in the CSI-RS corresponding to the beam, which represents a power ratio of the CSI-RS to a cell-specific reference signal (CRS). In this implementation, if the power of the beam is adjusted, the Pc corresponding to the beam will also be adjusted, which is different for configuration of each beam in different resource subsets.

In this implementation, the power allocation of the energy of the beam may also be indicated by using dynamic signaling, which represents an offset value of actual transmission power of the beam relative to power centralized in one beam for transmission. A purpose of doing in this way is to ensure correct demodulation of the DM-RSs. In this implementation, the dynamic signaling is, for example, 3 bits, corresponding to {1, ½, ⅓, ¼, ⅕, ⅙, 1/7, ⅛}, or 2 bits, corresponding to {1, a, b, c} configured by a high layer, and the eNB dynamically indicates actually-used transmission power by using the signaling of 3 bits or 2 bits.

In another implementation, the eNB may perform interference coordination on an interference beam by increasing width of the interference beam.

FIG. 6 is a schematic diagram of an implementation scenario of this implementation. As shown in FIG. 6, by increasing widths of the beams in the right cell, the flashlight effect is weakened, and interference on the beams in the left cell is reduced.

In this implementation, gain of beam-forming may be adjusted by changing shape of the beam, thus, power distribution in a beam radiation range is changed. In this implementation, the eNB may increase the width of the interference beam by changing weight of its transmitting antenna. However, this embodiment is not limited thereto. If the beam of the antenna is relatively wide, its power is relatively small, and interference on the neighboring cells is also reduced.

In this implementation, in order to support the eNB to adjust the shape of the beam, the eNB may further configure the user equipment to perform measurement on beams of different widths, and the prior art may be referred to for a configuration manner and a measurement manner, which shall not be described herein any further.

In another implementation, the eNB may perform interference coordination on the interference beam by scheduling multiple user equipment at the same time on the interference beam and other beams.

FIG. 7 is a schematic diagram of an implementation scenario of this implementation. As shown in FIG. 7, different user equipment are scheduled on different beams, thereby reducing power on each beam. On the basis of reducing interference on the neighboring cells, a throughput of a local cell may also be increased by scheduling relatively more user equipment. And in a three-dimensional multiple input multiple output (3D MIMO) system, multiple UEs MIMO is a common configuration, and interference on user equipment of other cells may be reduced by flexibly UE scheduling.

In this implementation, power of each user equipment may be flexibly allocated, and in order to ensure correct demodulation of the user equipment, the eNB may further inform the user equipment of information on the number of beams used by it, etc.

In this embodiment, the above manners of interference coordination may be implemented separately, and may also be implemented jointly, and this embodiment is not limited thereto.

In this embodiment, in order to ensure that the eNB end may use reasonably an interference coordination scheme, coordination information, such as the above-described interference coordination request, may be exchanged between eNBs. The coordination information may be beam-based signaling, and correspond to an identification of each beam.

In an implementation of this embodiment, as a receiver end of an interference coordination request, the eNB may receive an interference coordination request from other eNB. The interference coordination request may include: an identification of a beam used by the other eNB, and/or an identification of a beam with power greater than predefined power in beams used by the other eNB, and/or an identification of a beam subjected to interference greater than a predefined value in beams used by the other eNB. Optionally, the eNB may also receive information on the number and/or power and/or spatial directions of beams used by the other eNB, and/or a time-frequency resource to which each beam corresponds transmitted by the other eNB.

In another implementation of this embodiment, as a transmitter end of an interference coordination request, the eNB may transmit an interference coordination request to other eNB of a possible interfering cell. The interference coordination request may include: an identification of a beam used by the eNB, and/or an identification of a beam with power greater than predefined power in beams used by the eNB, and/or an identification of a beam subjected to interference greater than a predefined value in beams used by the eNB. Optionally, the eNB may also transmit information on the number and/or power and/or spatial directions of beams used by the eNB, and/or a time-frequency resource to which each beam corresponds to the other eNB.

In this implementation, each eNB informs the possible interfering cell of the identification of the beam, indicating which beams shall be used, or the beams shall be used at relatively large power, or the eNB informs a neighboring cell of information on that relatively intense interference is received on some beams, expecting the neighboring cell to perform interference coordination. Furthermore, eNBs may also exchange information related to beams, such as the number of the beams, the power of the beams, information on a spatial direction (horizontal or vertical), and a time-frequency resource to which each beam corresponds, etc.. In this implementation, the above information may be simplified. For example, the power of a beam may be indicated by two states, 1 representing that information is transmitted on the beam, and 0 representing that no information is transmitted on the beam. Hence, the eNB may be assisted to perform interference coordination with reference to the information.

With the interference coordination method of this embodiment, the interference coordination is performed in a manner of lowering power or changing time-frequency resources, which may efficiently suppress inter-cell interference, and achieve improvement of an average throughput of a cell.

### Embodiment 2

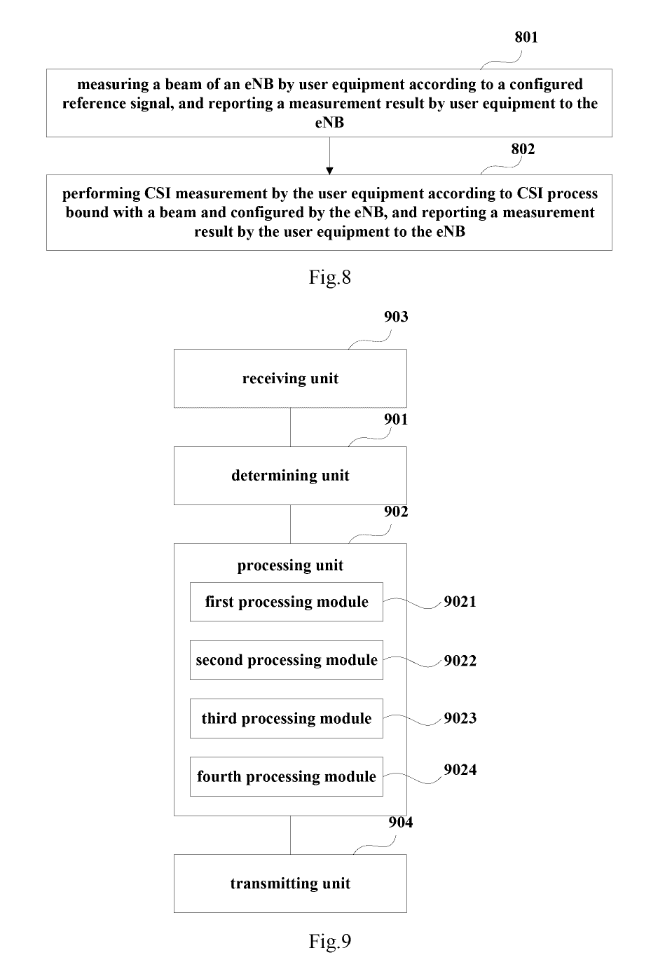

An embodiment of the present disclosure further provides an interference coordination method, which is processing at a UE side corresponding to the method of Embodiment 1. FIG. 8 is a flowchart of the method. Referring to FIG. 8, the method includes:
step 801: measuring a beam of an eNB by user equipment according to a configured reference signal, and reporting a measurement result by user equipment to the eNB; and
step 802: performing CSI measurement by the user equipment according to CSI process bound with a beam and configured by the eNB, and reporting a measurement result by the user equipment to the eNB, so that the eNB determines an interference beam interfering with a beam of other cell according to the measurement result reported by the user equipment and/or an interference coordination request transmitted by other eNB, performs interference coordination on the interference beam, and selects an appropriate beam for transmission to the user equipment.

In this embodiment, the process of performing measurement by the user equipment based on the beams is described in detail in Embodiment 1, and shall not be described herein any further.

In an implementation of this embodiment, if the eNB performs interference coordination on an interference beam by coordinating time-frequency resources used by the interference beam with other eNB, the eNB may possibly indicate the beams used by the user equipment for transmission via dynamic signaling and/or high-layer signaling, and in this embodiment, the user equipment may further receive the beams used in transmission indicated by the eNB via the dynamic signaling and/or high-layer signaling, a detailed indication manner having been described in detail in Embodiment 1, and being not going to be described herein any further.

In an implementation of this embodiment, if the eNB performs interference coordination on an interference beam by lowering transmission power of the interference beam, the eNB may possibly inform information on energy allocation of the beam to the user equipment, and in this embodiment, the user equipment may further receive the information on energy allocation of the beam used in transmission transmitted by the eNB, a detailed informing manner having been described in detail in Embodiment 1, and being not going to be described herein any further.

In an implementation of this embodiment, if the eNB performs interference coordination on an interference beam by increasing width of the interference beam, the eNB may possibly configure the user equipment to perform measurement on beams of different widths, and in this embodiment, the user equipment may further measure beams of different widths according to the configuration of the eNB.

In an implementation of this embodiment, if the eNB performs interference coordination on an interference beam by scheduling multiple user equipment at the same time on the interference beam and other beams, the eNB may possibly inform the user equipment of the number of beams used in transmission, and in this embodiment, the user equipment may further receive the number of beams used in transmission transmitted by the eNB.

With the interference coordination method of this embodiment, inter-cell interference may be efficiently suppressed, and improvement of an average throughput of a cell may be achieved.

### Embodiment 3

An embodiment of the present disclosure further provides an interference coordination apparatus, which is applicable to an eNB. As principles of the apparatus for solving problems are similar to that of the method of Embodiment 1, implementation of the method of Embodiment 1 may be referred to for particular implementation of the apparatus, with identical contents being not going be described herein any further.

FIG. 9 is a schematic diagram of a structure of the interference coordination apparatus. Referring to FIG. 9, the apparatus 900 includes:
a determining unit 901 configured to determine an interference beam interfering with a beam of other cell according to a measurement result reported by user equipment and/or an interference coordination request transmitted by other eNB; and
a processing unit 902 configured to perform interference coordination on the interference beam.

In an implementation of this embodiment, the processing unit 902 includes:
a first processing module 9021 configured to perform interference coordination on the interference beam by coordinating with the other eNB for a time-frequency resource used by the interference beam, such that time-frequency resources used by the interference beam and the beam of the other eNB interfering with the interference beam for scheduling user equipment are different.

In this implementation, the first processing module 9021 may further indicate a beam used in transmission to the user equipment via dynamic signaling and/or high-layer signaling. In this implementation, the first processing module 9021 may indicate the beam used in transmission to the user equipment by using an explicit beam indication field (BIF) bit, may indicate a beam used in transmission and a port index of a demodulation reference signal (DM-RS) used in the beam to the user equipment via a bit field, may indicate a serial number of the beam used in transmission in a beam group to the user equipment via dynamic signaling; wherein, the beam group is divided according to relevance of beams of the eNB and indicated via semi-static signaling.

In another implementation of this embodiment, the processing unit 902 includes:
a second processing module 9022 configured to perform interference coordination on the interference beam by reducing transmission power of the interfering beam.

In this implementation, the second processing module 9022 may further transmit energy allocation information of the beam used in transmission to the user equipment. In this implementation, the energy allocation information is power information of the beam in a time domain or frequency domain; and wherein the power information may be indicated via a Pc parameter in a CSI-RS corresponding to the beam, which represents a power ratio of the CSI-RS to a CRS.

In another implementation of this embodiment, the processing unit 902 includes:
a third processing module 9023 configured to perform interference coordination on the interference beam by increasing a width of the interfering beam.

In this implementation, the third processing module 9023 may increase the width of the interfering beam by changing weight of transmitting antenna of the beam.

In this implementation, the third processing module 9023 may further configure the user equipment to perform measurement on beams of different widths.

In another implementation of this embodiment, the processing unit 902 includes:
a fourth processing module 9024 configured to perform interference coordination on the interference beam by scheduling multiple user equipment at the same time on the interfering beam and other beams.

In this implementation, the fourth processing module 9024 may further notify the user equipment of the number of beams used in transmission.

In an implementation of this embodiment, as a receiver end of signaling interchange, the apparatus 900 may further include:
a receiving unit 903 configured to receive an interference coordination request transmitted by the other eNB, the interference coordination request including: an identification of a beam used by the other eNB, and/or an identification of a beam with power greater than predefined power in beams used by the other eNB, and/or an identification of a beam subjected to interference greater than a predefined value in beams used by the other eNB. Optionally, the receiving unit 903 may also receive information on the number and/or power and/or spatial directions of beams used by the other eNB, and/or a time-frequency resource to which each beam corresponds transmitted by the other eNB.

In another implementation of this embodiment, as a transmitter end of signaling interchange, the apparatus 900 may further include:
a transmitting unit 904 configured to transmit an interference coordination request to an eNB of a possible interfering cell, the interference coordination request including: an identification of a beam used by the eNB, and/or an identification of a beam with power greater than predefined power in beams used by the eNB, and/or an identification of a beam subjected to interference greater than a predefined value in beams used by the eNB. Optionally, the transmitting unit 904 may also transmit information on the number and/or power and/or spatial directions of beams used by the eNB, and/or a time-frequency resource to which each beam corresponds to the other eNB.

With the interference coordination apparatus of this embodiment, the interference coordination is performed in a manner of lowering power or changing time-frequency resources, which may efficiently suppress inter-cell interference, and achieve improvement of an average throughput of a cell.

### Embodiment 4

An embodiment of the present disclosure further provides an eNB, including the interference coordination apparatus as described in Embodiment 3.

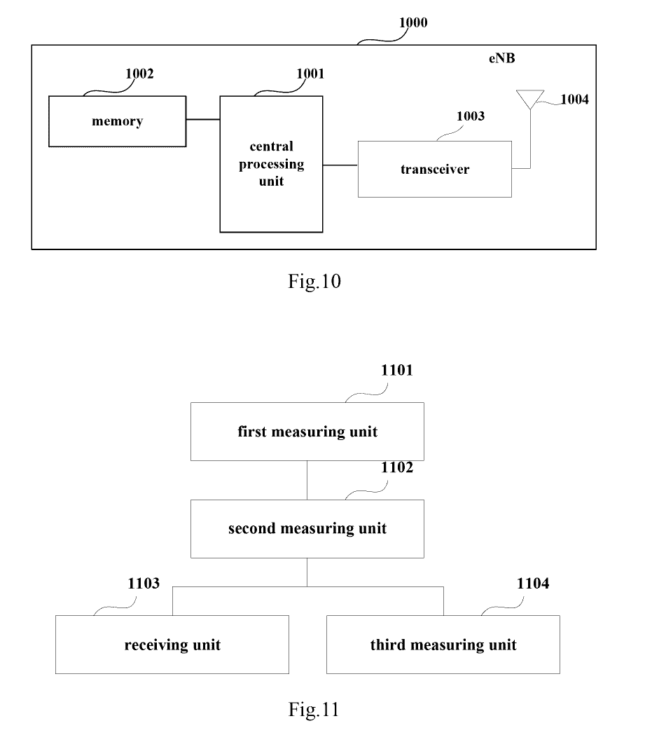

FIG. 10 is a schematic diagram of a structure of the eNB of this embodiment of the present disclosure. As shown in FIG. 10, the eNB 1000 may include a central processing unit (CPU) 1001 and a memory 1002, the memory 1002 being coupled to the central processing unit 1001. In this embodiment, the memory 1002 may store various data, and furthermore, may store programs for information processing, and execute the programs under control of the central processing unit 1001, so as to receive various information transmitted by the user equipment, and transmit request information to the user equipment.

In an implementation, the functions of the interference coordination apparatus may be integrated into the central processing unit 1001. In this implementation, the central processing unit 1001 may be configured to: determine an interference beam interfering with a beam of other cell according to a measurement result reported by user equipment and/or an interference coordination request transmitted by other eNB, and perform interference coordination on the interference beam.

In this implementation, the central processing unit 1001 may further be configured to perform interference coordination on the interference beam by coordinating with the other eNB for a time-frequency resource used by the interference beam, such that time-frequency resources used by the interference beam and the beam of the other eNB interfering with the interference beam for scheduling user equipment are different. Optionally, the central processing unit 1001 may further be configured to indicate a beam used in transmission to the user equipment via dynamic signaling and/or high-layer signaling. Optionally, the central processing unit 1001 may further be configured to indicate a beam used in transmission to the user equipment via an explicit beam indication field (BIF) bit, or indicate a beam used in transmission and a port index of a demodulation reference signal (DM-RS) used in the beam to the user equipment via a bit field, or indicate a serial number of the beam used in transmission in a beam group to the user equipment via dynamic signaling; wherein, the beam group is divided according to relevance of beams of the eNB and indicated via semi-static signaling.

In this implementation, the central processing unit 1001 may further be configured to perform interference coordination on interference beam by reducing transmission power of the interfering beam. Optionally, the central processing unit 1001 may further be configured to transmit energy allocation information of the beam used in transmission to the user equipment. In this implementation the energy allocation information is power information of the beam in a time domain or frequency domain; and wherein the power information is indicated via a Pc parameter in a CSI-RS corresponding to the beam, which represents a power ratio of the CSI-RS to a CRS.

In this implementation, the central processing unit 1001 may further be configured to perform interference coordination on the interference beam by increasing a width of the interfering beam. Optionally, the central processing unit 1001 may further be configured to increase the width of the interfering beam by changing weight of transmitting antenna of the interference beam. Optionally, the central processing unit 1001 may further be configured to configure the user equipment to perform measurement on beams of different widths.

In this implementation, the central processing unit 1001 may further be configured to perform interference coordination on the interference beam by scheduling multiple user equipment at the same time on the interfering beam and other beams. Optionally, the central processing unit 1001 may further be configured to notify the user equipment of the number of beams used in transmission.

Optionally, the central processing unit 1001 may further be configured to receive an interference coordination request transmitted by the other eNB, the interference coordination request including: an identification of a beam used by the other eNB, and/or an identification of a beam with power greater than predefined power in beams used by the other eNB, and/or an identification of a beam subjected to interference greater than a predefined value in beams used by the other eNB. Optionally, the central processing unit 1001 may further be configured to receive information on the number and/or power and/or spatial directions of beams used by the other eNB, and/or a time-frequency resource to which each beam corresponds transmitted by the other eNB.

Optionally, the central processing unit 1001 may further be configured to transmit an interference coordination request to an eNB of a possible interfering cell, the interference coordination request including: an identification of a beam used by the eNB, and/or an identification of a beam with power greater than predefined power in beams used by the eNB, and/or an identification of a beam subjected to interference greater than a predefined value in beams used by the eNB. Optionally, the central processing unit 1001 may further be configured to transmit information on the number and/or power and/or spatial directions of beams used by the eNB, and/or a time-frequency resource to which each beam corresponds to the other eNB.

In another implementation, the interference coordination apparatus and the central processing unit 1001 may be configured separately. For example, the interference coordination apparatus may be configured as a chip connected to the central processing unit 1001, with its functions being realized under control of the central processing unit 1001.

Furthermore, as shown in FIG. 10, the eNB 1000 may further include a transceiver 1003, and an antenna 1004, etc. In this embodiment, functions of the above components are similar to those in the prior art, and shall not be described herein any further. It should be noted that the eNB 1000 does not necessarily include all the parts shown in FIG. 10, and furthermore, the eNB 1000 may include parts not shown in FIG. 10, and the prior art may be referred to.

With the eNB of this embodiment, the interference coordination is performed in a manner of lowering power or changing time-frequency resources, which may efficiently suppress inter-cell interference, and achieve improvement of an average throughput of a cell.

### Embodiment 5

An embodiment of the present disclosure further provides an interference coordination apparatus. As principles of the apparatus for solving problems are similar to that of the method of Embodiment 2, implementation of the method of Embodiment 2 may be referred to for particular implementation of the apparatus, with identical contents being not going be described herein any further.

FIG. 11 is a schematic diagram of a structure of the interference coordination apparatus. Referring to FIG. 11, the apparatus 1100 includes:
a first measuring unit 1101 configured to perform measurement on a beam of an eNB according to a configured reference signal, and report a measurement result to the eNB; and
a second measuring unit 1102 configured to perform CSI measurement according to CSI process bound with a beam and configured by the eNB, and report a measurement result to the eNB, so that the eNB determines an interference beam interfering with a beam of other cell according to the measurement result reported by the user equipment and/or an interference coordination request transmitted by other eNB, performs interference coordination on the interference beam, and selects an appropriate beam for transmission to the user equipment.

In this embodiment, the apparatus 1100 may further include:
a receiving unit 1103 configured to receive a beam used in transmission and indicated by the eNB via dynamic signaling and/or high-layer signaling, and/or energy allocation information of a beam used in transmission, and/or the number of beams used in transmission. The information received by the receiving unit 1103 corresponds to the information transmitted by the first, second and fourth processing modules in Embodiment 3, with details being as described above, and being not going to be described herein any further.

In this embodiment, the apparatus 1100 may further include:
a third measuring unit 1104 configured to perform measurement on beams of different widths according to configuration of the eNB. The third measuring unit 1104 performs the measurement based on the configuration of the third processing module in Embodiment 3, with details being as described above, and being not going to be described herein any further.

With the interference coordination apparatus of this embodiment, inter-cell interference may be efficiently suppressed, and improvement of an average throughput of a cell may be achieved.

### Embodiment 6

An embodiment of the present disclosure further provides user equipment, including the interference coordination apparatus as described in Embodiment 5.

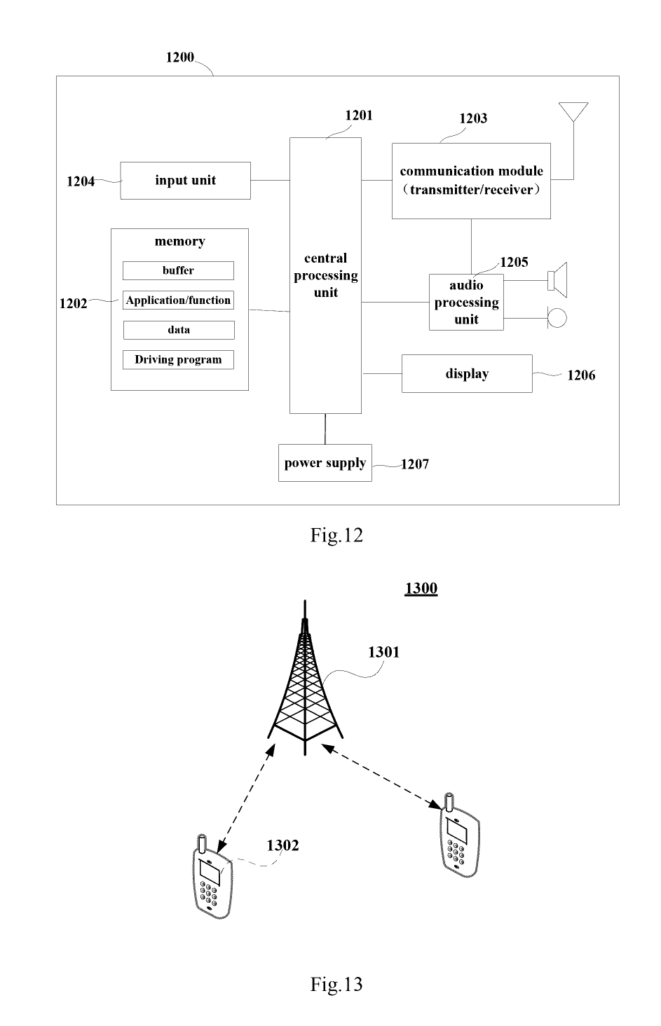

FIG. 12 is a block diagram of a systematic structure of the user equipment 1200 of the embodiment of the present disclosure. As shown in FIG. 12, the user equipment 1200 may include a central processing unit 1201 and a memory 1202, the memory 1202 being coupled to the central processing unit 1201. It should be noted that this figure is illustrative only, and other types of structures may also be used, so as to supplement or replace this structure and achieve telecommunications function or other functions.

In an implementation, the functions of the interference coordination apparatus may be integrated into the central processing unit 1201. In this implementation, the central processing unit 1201 may further be configured to: perform measurement on a beam of an eNB according to a configured reference signal, and report a measurement result to the eNB; and perform CSI measurement according to CSI process bound with a beam and configured by the eNB, and report a measurement result to the eNB, so that the eNB determines an interference beam interfering with a beam of other cell according to the measurement result reported by the user equipment and/or an interference coordination request transmitted by other eNB, performs interference coordination on the interference beam, and selects an appropriate beam for transmission to the user equipment.

Optionally, the central processing unit 1201 may further be configured to receive a beam used in transmission and indicated by the eNB via dynamic signaling and/or high-layer signaling, and/or energy allocation information of a beam used in transmission, and/or the number of beams used in transmission.

Optionally, the central processing unit 1201 may further be configured to perform measurement on beams of different widths according to configuration of the eNB.

In another implementation, the interference coordination apparatus and the central processing unit 1201 may be configured separately. For example, the interference coordination apparatus may be configured as a chip connected to the central processing unit 1201, with its functions being realized under control of the central processing unit 1201.

As shown in FIG. 12, the user equipment 1200 may further include a communication module 1203, an input unit 1204, an audio processing unit 1205, a display 1206, and a power supply 1207. It should be noted that the user equipment 1200 does not necessarily include all the parts shown in FIG. 12, and furthermore, the user equipment 1200 may include parts not shown in FIG. 12, and the prior art may be referred to.

As shown in FIG. 12, the central processing unit 1201 is sometimes referred to as a controller or control, and may include a microprocessor or other processor devices and/or logic devices. The central processing unit 1201 receives input and controls operations of every components of the user equipment 1200.

In this embodiment, the memory 1202 may be, for example, one or more of a buffer memory, a flash memory, a hard drive, a mobile medium, a volatile memory, a nonvolatile memory, or other suitable devices, which may store predefined or preconfigured information, and may further store a program executing related information. And the central processing unit 1201 may execute the program stored in the memory 1202, so as to realize information storage or processing, etc. Functions of other parts are similar to those of the prior art, which shall not be described herein any further. The parts of the user equipment 1200 may be realized by specific hardware, firmware, software, or any combination thereof, without departing from the scope of the present disclosure.

With the user equipment of this embodiment, inter-cell interference may be efficiently suppressed, and improvement of an average throughput of a cell may be achieved.

### Embodiment 7

An embodiment of the present disclosure further provides a communication system, including the eNB as described in Embodiment 4 and the user equipment as described in Embodiment 6.

FIG. 13 is a schematic diagram of a structure of the communication system of the embodiment of the present disclosure. As shown in FIG. 13, the communication system 1300 includes an eNB 1301 and user equipment 1302. In this embodiment, the eNB 1301 may be the eNB 1000 as described in Embodiment 4, and the user equipment 1302 may be the user equipment 1200 as described in Embodiment 6.

In this embodiment, the user equipment 1302 is configured to perform measurement on a beam of the eNB 1301 according to a configured reference signal, report a measurement result to the eNB 1301, perform CSI measurement according to CSI process bound with a beam and configured by the eNB 1301, and report a measurement result to the eNB 1301;

In this embodiment, the eNB 1301 is configured to determine an interference beam interfering with a beam of other cell according to a measurement result reported by the user equipment 1302 and/or an interference coordination request transmitted by other eNB, and perform interference coordination on the interference beam.

In this embodiment, the eNB 1301 is configured to perform interference coordination on the interference beam in the following manners: coordinating with the other eNB for a time-frequency resource used by the interference beam, such that time-frequency resources used by the interference beam and the beam of the other eNB interfering with the interference beam for scheduling the user equipment are different, and/or reducing transmission power of the interfering beam, and/or increasing a width of the interfering beam, and/or scheduling multiple user equipment at the same time on the interfering beam and other beams.

In this embodiment, the eNB 1301 is further configured to receive an interference coordination request transmitted by the other eNB, the interference coordination request including: an identification of a beam used by the other eNB, and/or an identification of a beam with power greater than predefined power in beams used by the other eNB, and/or an identification of a beam subjected to interference greater than a predefined value in beams used by the other eNB. Optionally, the eNB 1301 is further configured to receive information on the number and/or power and/or spatial directions of beams used by the other eNB, and/or a time-frequency resource to which each beam corresponds, transmitted by the other eNB.

In this embodiment, the eNB 1301 is further configured to transmit an interference coordination request to an eNB of a possible interfering cell; wherein the interference coordination request includes: an identification of a beam used by the eNB, and/or an identification of a beam with power greater than predefined power in beams used by the eNB, and/or an identification of a beam subjected to interference greater than a predefined value in beams used by the eNB. Optionally, the eNB 1301 is further configured to transmit information on the number and/or power and/or spatial directions of beams used by the eNB, and/or a time-frequency resource to which each beam corresponds to the other eNB.

With the communication system of this embodiment, the eNB performs interference coordination in a manner of lowering power or changing time-frequency resources, which may efficiently suppress inter-cell interference, and achieve improvement of an average throughput of a cell.

An embodiment of the present disclosure further provides a computer-readable program, wherein when the program is executed in an eNB, the program enables the eNB to carry out the interference coordination method as described in Embodiment 1.

An embodiment of the present disclosure provides a storage medium in which a computer-readable program is stored, wherein the computer-readable program enables an eNB to carry out the interference coordination method as described in Embodiment 1.

An embodiment of the present disclosure further provides a computer-readable program, wherein when the program is executed in user equipment, the program enables the user equipment to carry out the interference coordination method as described in Embodiment 2.

An embodiment of the present disclosure provides a storage medium in which a computer-readable program is stored, wherein the computer-readable program enables user equipment to carry out the interference coordination method as described in Embodiment 2 in user equipment.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principles of the present disclosure, and such variants and modifications fall within the scope of the present disclosure.

What is claimed is:

1. An interference coordination apparatus, applicable to an eNB, wherein the apparatus comprises:
a determining unit configured to determine an interference beam interfering with a beam of other cell according to a measurement result reported by user equipment and/or an interference coordination request transmitted by other eNB; and
a processing unit configured to perform interference coordination on the interference beam.

2. The apparatus according to claim 1, wherein the processing unit comprises:
a first processing module configured to coordinate with the other eNB for a time-frequency resource used by the interference beam, so that time-frequency resources used by the interference beam and the beam of the other eNB interfering with the interference beam for scheduling user equipment are different.

3. The apparatus according to claim 2, wherein,
the first processing module indicates a beam used in transmission to the user equipment via an explicit beam indication field (BIF) bit; or
the first processing module indicates a beam used in transmission and a port index of a demodulation reference signal (DM-RS) used in the beam to the user equipment via a bit field; or
the first processing module indicates a serial number of the beam used in transmission in a beam group to the user equipment via dynamic signaling; wherein, the beam group is divided according to relevance of beams of the eNB and indicated via semi-static signaling; or
the first processing module indicates a beam used in transmission to the user equipment via high-layer signaling.

4. The apparatus according to claim 1, wherein the processing unit comprises:
a second processing module configured to reduce transmission power of the interfering beam.

5. The apparatus according to claim 4, wherein,
the second processing module transmits energy allocation information of the beam used in transmission to the user equipment.

6. The apparatus according to claim 5, wherein the energy allocation information is power information of the beam in a time domain or frequency domain.

7. The apparatus according to claim 5, wherein the energy allocation information is indicated via dynamic signaling in a manner of power allocation of beam energy, and represents an offset value of actual transmission power of the beam relative to power centralized in one beam for transmission.

8. The apparatus according to claim 1, wherein the processing unit comprises:
a third processing module configured to adjust a width of the interfering beam.

9. The apparatus according to claim 8, wherein,
the third processing module further configures the user equipment to perform measurement on beams of different widths.

10. The apparatus according to claim 1, wherein the processing unit comprises:
a fourth processing module configured to schedule multiple user equipment on the interfering beam and other beams.

11. The apparatus according to claim 10, wherein,
the fourth processing module further notifies the user equipment of the number of beams used in transmission.

12. The apparatus according to claim 1, wherein the apparatus further comprises:
a receiving unit configured to receive an interference coordination request transmitted by the other eNB;
and the interference coordination request comprises: an identification of a beam used by the other eNB, and/or an identification of a beam with power greater than predefined power in beams used by the other eNB, and/or an identification of a beam subjected to interference greater than a predefined value in beams used by the other eNB, and/or information on the number and/or power and/or spatial directions of beams used by the other eNB, and/or a time-frequency resource to which each beam corresponds.

13. The apparatus according to claim 1, wherein the apparatus further comprises:
a transmitting unit configured to transmit an interference coordination request to an eNB of a possible interfering cell;
and the interference coordination request comprises: an identification of a beam used by the eNB, and/or an identification of a beam with power greater than predefined power in beams used by the eNB, and/or an identification of a beam subjected to interference greater than a predefined value in beams used by the eNB, and/or information on the number and/or power and/or spatial directions of beams used by the eNB, and/or a time-frequency resource to which each beam corresponds.

14. An interference coordination apparatus, applicable to user equipment, wherein the apparatus comprises:
a first measuring unit configured to perform measurement on a beam of an eNB according to a configured reference signal, and report a measurement result to the eNB; and
a second measuring unit configured to perform channel station information (CSI) measurement according to CSI process bound with a beam and configured by the eNB, and report a measurement result to the eNB, so that the eNB determines an interference beam interfering with a beam of other cell according to the measurement result reported by the user equipment and/or an interference coordination request transmitted by other eNB, performs interference coordination on the interference beam, and selects an appropriate beam for transmission to the user equipment.

15. The apparatus according to claim 14, wherein the apparatus further comprises:
a receiving unit configured to receive a beam used in transmission and indicated by the eNB via dynamic signaling and/or high-layer signaling, and/or energy allocation information of a beam used in transmission, and/or the number of beams used in transmission.

16. The apparatus according to claim 14, wherein the apparatus further comprises:
a third measuring unit configured to perform measurement on beams of different widths according to configuration of the eNB.

17. A communication system, comprising an eNB and user equipment, wherein,
the user equipment is configured to perform measurement on a beam of an eNB according to a configured reference signal, report a measurement result to the eNB, perform channel station information (CSI) measurement according to CSI process bound with a beam and configured by the eNB, and report a measurement result to the eNB;
and the eNB is configured to determine an interference beam interfering with a beam of other cell according to a measurement result reported by the user equipment and/or an interference coordination request transmitted by other eNB, and perform interference coordination on the interference beam.

18. The communication system according to claim 17, wherein the eNB is configured to:
coordinate with the other eNB for a time-frequency resource used by the interference beam, so that time-frequency resources used by the interference beam and the beam of the other eNB interfering with the interference beam for scheduling the user equipment are different; and/or
reduce transmission power of the interfering beam; and/or
increase a width of the interfering beam; and/or
schedule multiple user equipment on the interfering beam and other beams.

19. The communication system according to claim 17, wherein the eNB is further configured to:
receive an interference coordination request transmitted by the other eNB; wherein the interference coordination request comprises: an identification of a beam used by the other eNB, and/or an identification of a beam with power greater than predefined power in beams used by the other eNB, and/or an identification of a beam subjected to interference greater than a predefined value in beams used by the other eNB, and/or information on the number and/or power and/or spatial directions of beams used by the other eNB, and/or a time-frequency resource to which each beam corresponds.

20. The communication system according to claim 17, wherein the eNB is further configured to:
transmit an interference coordination request to an eNB of a possible interfering cell; wherein the interference coordination request comprises: an identification of a beam used by the eNB, and/or an identification of a beam with power greater than predefined power in beams used by the eNB, and/or an identification of a beam subjected to interference greater than a predefined value in beams used by the eNB, and/or information on the number and/or power and/or spatial directions of beams used by the eNB, and/or a time-frequency resource to which each beam corresponds.
